(19) United States
(12) Patent Application Publication
(10) Pub. No.: US 2025/0258140 A1
(43) Pub. Date: Aug. 14, 2025

(54) MECHANICAL EXCITATION FOR ACOUSTIC INTERROGATION OF MATERIALS

(71) Applicant: Brigham Young University (BYU), Provo, UT (US)

(72) Inventor: Brian Anthony Mazzeo, Provo, UT (US)

(21) Appl. No.: 19/049,941

(22) Filed: Feb. 10, 2025

Related U.S. Application Data
(60) Provisional application No. 63/551,383, filed on Feb. 8, 2024.

(51) Int. Cl. G01N 29/14

(52) U.S. Cl. CPC G01N 29/14; G01N 2291/102; G01N 2291/103; G01N 2291/105; G01N 2291/263

(57) ABSTRACT

A system includes an acoustic exciter that is configured to be supported by a platform. The acoustic exciter includes a plurality of excitation elements that rotate about an axis of rotation to cause acoustic excitation of a substrate via contact with the substrate. The acoustic exciter is repositionable relative to the platform to alter an excitation path that is applied to the substrate by the excitation elements. The system further includes a sensor that is configured to sense an acoustic response of the acoustic excitation.

### CROSS-REFERENCE TO RELATED APPLICATION

This application claims the benefit of the filing date of U.S. Provisional Patent Application No. 63/551,383, filed on Feb. 8, 2024, the disclosure of which is incorporated herein by reference.

### TECHNICAL FIELD

This document relates, generally, to continuous and/or semi-continuous acoustic excitation of surfaces for acoustic interrogation of materials.

### BACKGROUND

Reinforced concrete is one of the most important structural components and has influenced civil infrastructure all over the world. Given the volume of reinforced concrete in the world, its deterioration is one of the most pressing global problems and has inspired investigations by scientists and engineers to enable accurate prediction of the deterioration of reinforced concrete. Scientifically validated assessment tools and techniques are needed to enable identification and prioritization of infrastructure rehabilitation projects, especially in scenarios where addressing such challenges may have a political dimension.

Bridges are vital elements of modern infrastructure. And of all the elements of a bridge, the bridge deck is typically the most susceptible to deterioration, for example due to repeated mechanical loading and exposure to corrosive elements. Not surprisingly, a great deal of attention is placed on inspecting and maintaining bridge decks. However, evaluation and rehabilitation of bridge decks can be particularly challenging because bridge decks are often under traffic, access is limited, and expensive, disruptive traffic control is often necessary. In current practice, bridge evaluation is commonly performed via visual inspection. However, some signs of distress in reinforced concrete structures, such as internal delaminations between layers of concrete, are difficult if not impossible to adequately assess by visual inspection alone.

### SUMMARY

In an aspect, a system may include an acoustic exciter that is configured to be supported by a platform. The acoustic exciter may include a plurality of excitation elements that rotate about an axis of rotation to cause acoustic excitation of a substrate via contact with the substrate. The acoustic exciter may be repositionable relative to the platform to alter an excitation path that is applied to the substrate by the excitation elements. The system may further include a sensor that is configured to sense an acoustic response of the acoustic excitation.

In another aspect, a system may include an acoustic exciter having a plurality of excitation elements. The acoustic exciter may be configured to maintain substantially continuous contact of the plurality of excitation elements with a substrate. The acoustic exciter may further include a motor that is configured to agitate the plurality of excitation elements to cause acoustic excitation of the substrate. The system may further include a sensor that is oriented to sense an acoustic response of the acoustic excitation.

In still another aspect, an acoustic exciter may include a plurality of excitation elements that are configured to contact a substrate to cause acoustic excitation in the substrate. The acoustic exciter may further include a head that is configured to support the plurality of excitation elements in a hanging arrangement. The acoustic exciter may further include a shaft having a first end that is coupled to the head and a second end that is spaced from the first end. The shaft may define an axis of rotation of the head. The acoustic exciter may further include a motor that is coupled to the second end of the shaft and configured to rotate the shaft about the axis of rotation. The acoustic exciter may further include a coupler that is configured to mount the motor to a platform such that the motor is repositionable relative to the platform to vary an angle between the axis of rotation and a surface of the substrate.

### BRIEF DESCRIPTION OF DRAWINGS

FIG. 1 is a block diagram of an example of an acoustic excitation system in accordance with the present disclosure.

FIG. 2A is a perspective view of an example acoustic exciter in accordance with the present disclosure.

FIG. 2B is a perspective view of the example acoustic exciter illustrated in FIG. 2A in operation, in accordance with the present disclosure.

FIG. 3 is a side view of the example acoustic exciter illustrated in FIG. 2A in operation, with the acoustic exciter repositioned relative to a platform.

FIG. 4 is a top view of a head that may be implemented in an example acoustic exciter in accordance with the present disclosure.

FIG. 5A is a top view of another example acoustic exciter in accordance with the present disclosure.

FIG. 5B is a top view of the example acoustic exciter illustrated in FIG. 5A in operation, in accordance with the present disclosure.

FIG. 6A is a block diagram depicting an example arrangement of sensors for an acoustic excitation system in accordance with the present disclosure.

FIGS. 6B-6C are spectrograms depicting data collected by the sensors during operation of the acoustic excitation system illustrated in FIG. 6A.

FIG. 7 is a block diagram depicting another example arrangement of sensors for an acoustic excitation system in accordance with the present disclosure.

FIG. 8 is a block diagram of another example of an acoustic excitation system in accordance with the present disclosure.

FIG. 9 is a block diagram the depicts an example of excitation paths applied by acoustic exciters of the acoustic excitation system illustrated in FIG. 8.

FIG. 10 is a flow diagram of an example process for operating an acoustic excitation system in accordance with the present disclosure.

FIG. 11 is a spectrogram from an acoustic excitation interrogation performed using the example process illustrated in FIG. 10.

### DETAILED DESCRIPTION

The present disclosure relates to one or more acoustic exciters that acoustically excite a substrate. The present subject matter can make use of an ability to automatically perform data analysis of an acoustic response from a material to determine one or more characteristics of the material. In some implementations, it can be determined whether the material has subsurface cracking. For example, this can indicate that a delamination is present in the material.

A more versatile and continuous excitation of a tested material can be provided. In some implementations, versatility may be enhanced due to one or more exciters having repositionable components and/or due to exciters having compact, highly maneuverable configurations. When one or more excitation elements of an exciter break contact with the surface of a material being interrogated, for example due to rebounding, effectiveness of acoustic measurements may be reduced. In some implementations, one or more exciters are configured such that excitation elements of the exciters maintain substantially continuous contact with the surface of the material. For the purposes of the present disclosure, continuous (e.g., substantially continuous) acoustic excitation refers to a plurality of excitation elements making contact with, for instance impacting, a material at a frequency such that multiple discrete impacts with the material sound continuous to a human ear but are, in fact, individual impacts. In some implementations, the material being impacted may be a substrate, such as reinforce concrete.

Known acoustic exciters may lack the ability to perform acoustic excitation within confined spaces, which may make them unsuitable for interrogating materials in such spaces, such as decks within a parking structure, for example. An advantage of an exciter having a compact, highly maneuverable configuration may be the ability to conduct material interrogations within confined spaces, to conduct interrogation of material surfaces not at ground level (e.g., walls, ceilings), and so on.

Considering the many defects that occur within bridge decks, internal cracking known as delamination is a serious defect. In regions that experience routine application of deicing salts and in coastal regions, chlorides accumulate around the reinforcing steel in the bridge deck, causing rust. As the steel rusts, it expands, producing internal cracks within the concrete. Eventually the concrete spalls, and a pothole is formed. Significant rehabilitation is then necessary to restore reinforced concrete that has reached this advanced stage of deterioration. However, the earlier that detection of defects occurs, the more cost-effective and life-extending the rehabilitation of the bridge deck can be. It should be appreciated that applications of the apparatuses, systems, and methods described herein are not limited to bridge decks. Any concrete or other material made of homogenous or heterogeneous materials with the propensity to crack or disband, such as parking structures, roofs, dams, runways, etc. are within the scope of possible applications.

When an acoustic exciter acoustically excites a substrate, an acoustic response can be generated by the substrate. Such an acoustic response can be captured by one or more sensors (e.g., a microphone) and can be stored as an analog and/or digital signal. One or more processing techniques can be applied to the data of such a signal.

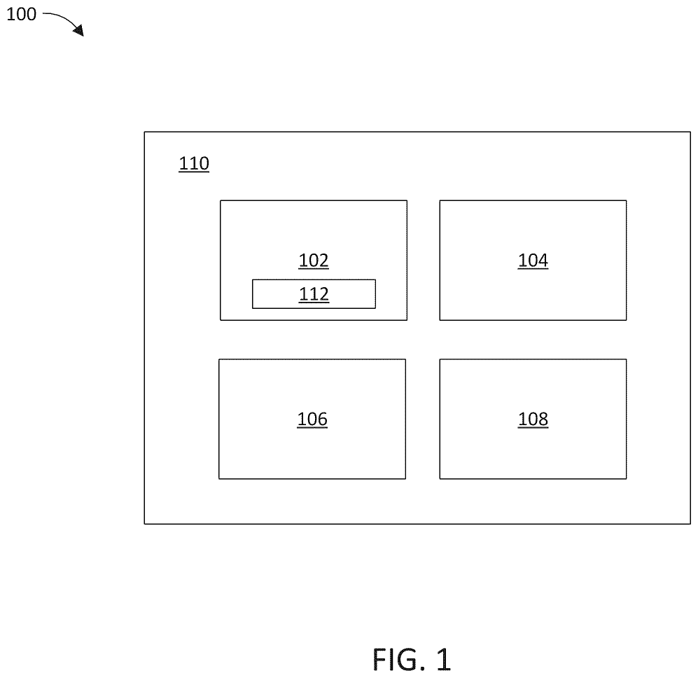

FIG. 1 is a block diagram of an example of an acoustic excitation system 100. The acoustic excitation system 100 may be generally referred to as a system. In some implementations, the acoustic excitation system 100 may include one or more exciters 102, one or more sensors 104, one or more analysis components 106, one or more location components 108, and a platform 110 to which one or more other components of the acoustic excitation system 100 may be mounted, in one or more combinations. As described herein, one or more components of the acoustic excitation system 100 can interact or otherwise cooperate with each other to perform acoustic excitation and record and analyze acoustic responses thereof.

As shown, the acoustic excitation system 100 includes a single exciter 102. The exciter 102 may be configured to cause acoustic excitation of a substrate, such as a portion of a reinforced concrete structure (e.g., a road), for example. The exciter 102 may be configured for manual excitation of the substrate, automatic excitation of the substrate, or a combination thereof.

The exciter 102 may include one or more components that make contact with the substrate to cause acoustic excitation within the substrate. For example, as shown the exciter 102 may include one or more excitation elements 112, such as a plurality of excitation elements 112. The excitation elements 112 may include any acoustic exciter, impactor and/or contact that may be moved (e.g., agitated) to trigger acoustic excitation in at least part of a material. The exciter 102 may be configured to maintain contact of at least one or more of the excitation elements 112 with the substrate during operation.

The one or more sensors 104 may be configured to sense an acoustic response of the acoustic excitation caused by the excitation elements 112. In some implementations, the one or more sensors 104 may be implemented as microphones (e.g., directional microphones). In some implementations, the one or more sensors 104 may be mounted such that they are located near the floor or ground so that they pick up impact responses from the material that is being interrogated. The microphones may be placed close to respective contact locations of the excitation elements 112 on a substrate, so that the sensing of ambient noise is mitigated relative to the acoustic response caused by acoustic excitation. In some implementations, the acoustic excitation system 100 may be configured as a multi-channel system that includes two or more sensors 104.

The one or more analysis components 106 may be configured to determine at least one characteristic of the substrate (e.g., the roadway or other material), for example using information related to the sensed acoustic response. In some implementations, the one or more analysis components 106 can include software, firmware, and/or hardware, in any combination. For example, in an example implementation, the one or more analysis components 106 may include circuitry that is configured to determine at least one characteristic of a substrate based on the acoustic response. In some implementations, the one or more analysis components 106 may be configured to receive and/or store signals from the one or more sensors 104 and to process the signals to determine characteristics of the substrate. To illustrate, the one or more analysis components 106 may be configured to perform analysis on data and/or information related to sensed acoustic response to determine whether one or more portions of a substrate contain delaminations.

The one or more location components 108 may include a positioning system. In some implementations, such a positioning system may include one or more location detectors. For example, positioning in the example implementations described herein may include, but are not limited to, use of differential global positioning system (DGPS) and/or light detection and ranging (LiDAR). Positioning can be achieved by many different methods including global positioning system (GPS), DGPS, real time kinematics GPS (RTK-GPS), odometry, computer vision, optics, radar, LiDAR, beacons, and/or a variety of other techniques, including computed telemetry in post-processing and simultaneous localization and mapping (SLAM) methods that can generate position data and/or generate maps as data are collected. These methods can be used to obtain the position information necessary to be able to generate maps either in real time or in post-processing conditions, for example.

The platform 110 may be configured to support one or more other components of the acoustic excitation system 100 during acoustic of a substrate. The platform 110 may be configured to remain in a static position and/or may be configured to be movable during operation of the acoustic excitation system 100. In some implementations, the platform 110 may be provided as a wheeled and/or tracked vehicle, such as a cart for example. The platform 110 may be configured to moved manually or may be configured for self-propelled movement, in any combination. In self-propelled implementations, the platform 110 may be configured to move in response to operator input, to move semi-autonomously, or to move autonomously, in any combination.

The one or more location components 108 may be configured to identify when the platform 110 is located at an area to be interrogated (e.g., when the platform 110 is traversing or about to traverse a portion of a bridge deck). In some implementations, the one or more location components 108 can be configured to correlate acoustic responses with the structure or surface being acoustically excited. For example, when acoustic response data indicates a possible delamination, data from the one or more location components 108 can be used to determine where on the measured substrate or object the delamination is located.

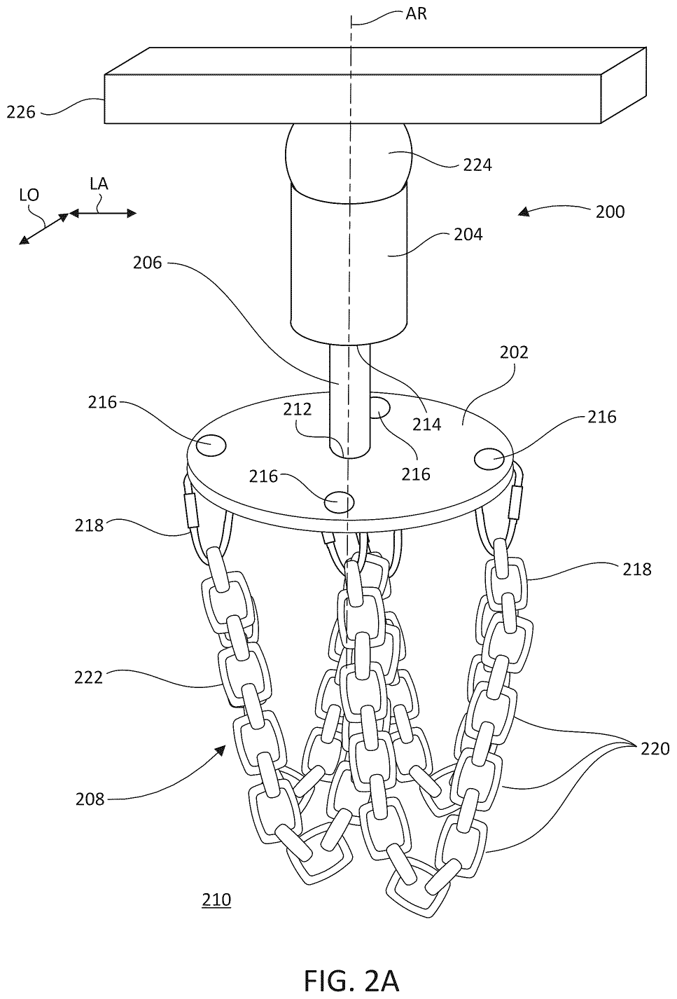

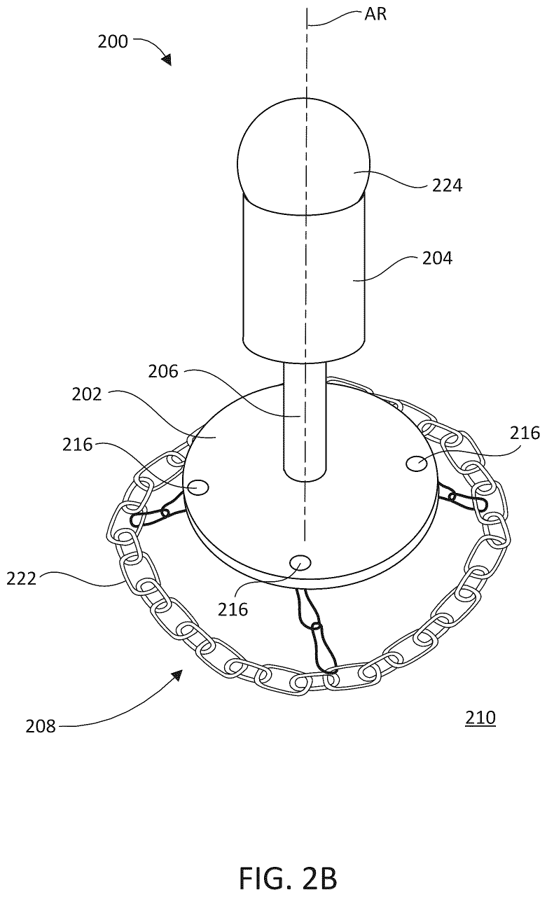

FIG. 2A is a perspective view of an example acoustic exciter 200. The acoustic exciter 200 may be implemented, for example, as the exciter 102 of the acoustic excitation system 100. In some implementations, the acoustic exciter 200 includes a head 202, a motor 204, a shaft 206 that couples the head 202 to the motor 204, and one or more excitation elements 208. As shown, the acoustic exciter 200 includes a plurality of excitation elements 208. The excitation elements 208 may be configured to contact a substrate 210 to cause acoustic excitation in the substrate 210.

In some implementations, the shaft 206 may have a first end 212 that is configured to be coupled to the head 202 and a second end 214 that is spaced from the first end 212. The second end 214 of the shaft 206 may be coupled to the motor 204. In some implementations, the second end 214 may be configured to be received in a chuck of the motor 204. In some implementations, the shaft 206 may be an integrated component of the motor 204.

The shaft 206 may define an axis of rotation AR of the head 202. For example, as shown the axis of rotation AR extends coaxially with a longitudinal axis of the shaft 206. The motor 204 is configured to rotate the shaft 206, and thus the head 202, about the axis of rotation AR.

In some implementations, the head 202 may be configured to support the plurality of excitation elements 208. For example, as shown the head 202 is configured to support the plurality of excitation elements 208 in a hanging arrangement. In some implementations, the head 202 may include one or more attachment locations 216 that are configured to enable attachment of the plurality of excitation elements 208 to the head 202. As shown, the head 202 is disc-shaped and includes four attachment locations 216 that are spaced apart from one another around a circumference of the head 202.

One or more of the attachment locations 216 may be configured to allow a portion of the plurality of excitation elements 208 to be attached to, and thereby suspended from, the head 202. For example, in an example implementation, each attachment location 216 may comprise an aperture configured to receive a fastener for connecting a portion of the plurality of excitation elements 208. In another example implementation, each attachment location 216 may include a ring-shaped structure that is attached to an underside of the head 202, such as an eyebolt, a carabiner clip, or the like.

In some implementations, acoustic exciter 200 may include one or more connecting elements 218 that enable attachment of the plurality of excitation elements 208 to the attachment locations 216. In some implementations, the connecting elements 218 may be configured to provide a non-rigid attachment between respective ones of the excitation elements 208 and the attachment locations 216, for instance such that an excitation element 208 is able to move freely while connected to an attachment location 216. In some implementation, the connecting elements 218 may be provided as carabiners, bolt snaps, split rings, loops of wire, loops of string, and so on. As shown, the acoustic exciter 200 may include one or more connecting elements 218 in the form of one or more carabiners at each attachment location 216 that attach the plurality of excitation elements 208 to the head 202 in a dangling arrangement. As shown, the acoustic exciter 200 may include one or more carabiners, connected to each other, at each attachment location 216. In some implementations, the acoustic exciter 200 may include more or fewer connecting elements 218, such as more or fewer carabiners. For example, in some implementations the acoustic exciter 200 may include no connecting elements, such that portions of the plurality of excitation elements 208 may be connected directly to respective ones of the attachment locations 216.

In some implementations, the excitation elements 208 may include a plurality of interconnected links 220, such as chain links. For example, in some implementations, the excitation elements 208 may be provided as one more lengths of chain 222. Chains 222 may provide multiple interactions across the surface of a substrate because they include many contact elements flexibly coupled together. Furthermore, the contact events they produce are inherently stochastic because one or more of spacing, contact duration, and timing may change as the excitation elements 208 are rotated. Other excitation elements, such as beads, rods, or balls on wires, for example, could be implemented in place of chain 222, but may not be preferred.

As shown, the plurality of excitation elements 208 is provided as a length of chain 222 that is connected at its loose ends by a quick link. As shown, the chain 222 is connected to the head 202 via carabiners at each attachment location 216, such that the chain 222 is divided into four segments of approximately the same length. In some implementations, the chain 222 may be provided in a length that exceeds the circumference of the head 202, such that each segment of the chain 222, for example as defined between adjacent attachment locations 216, hangs in a sagging manner. In this regard, the head 202 may be configured such that when the plurality of interconnected links 220 (e.g., the chain 222) is suspended from the plurality of attachment locations 216, respective segments of the plurality of interconnected links 220 exhibit sag between adjacent ones of the plurality of attachment locations 216.

In some implementations, the acoustic exciter 200 may include a coupler 224 that is configured to mount the motor 204 to a platform 226 (e.g., such as the platform 110 of the acoustic excitation system 100). The coupler 224 may be configured to enable repositioning of the motor 204 relative to the platform 226 in multiple degrees of freedom. For example, the coupler 224 may be configured such that the motor 204 is repositionable relative to the platform 226 to vary an angle between the axis of rotation AR and a surface of the substrate 210. For example, in some implementations, the coupler 224 may be configured to enable repositioning of the motor 204 such that the axis of rotation AR pivots about the coupler 224 in one or both of a longitudinal direction LO and a lateral direction LA. In some implementations, the coupler 224 may be configured for manual repositioning of the motor 204. For example, in such an implementation the coupler 224 may be provided as a ball head coupler or the like. In some implementations, the coupler 224 may be configured to automatic (e.g., actuator controlled) repositioning of the motor 204. For example, in such an implementation the coupler 224 may be provided as a multi-axis positioner.

FIG. 2B is a perspective view of the acoustic exciter 200 in operation. In some implementations, the motor 204 may be configured to agitate the plurality of excitation elements 208 to cause acoustic excitation. For example, as shown the motor 204 may be configured to drive rotation of the shaft 206, and thus the head 202, about the axis of rotation AR such that the plurality of excitation elements 208 make and maintain contact with the substrate 210.

In some implementations, the acoustic exciter 200 may be configured such that the motor 204 rotates the head 202 at a rotational speed that causes the plurality of excitation elements 208 to move in a predictable manner such that the excitation elements form an excitation path relative to the substrate 210. For example, as shown the motor 204 may be configured to rotate the head 202 at a rotational speed that causes the chain 222 to move in a substantially circular excitation path, wherein adjacent interconnected links 220 generally follow one another along the excitation path. This may result in an excitation path having a narrow, annular shape.

As shown, the motor 204 may be positioned, for example via the coupler 224, such that the axis of rotation AR is substantially orthogonal relative to a planar surface of the substrate 210. As the motor 204 rotates the head 202 about the axis of rotation AR, the excitation path may remain substantially circular and the plurality of excitation elements 208 may maintain substantially continuous contact with the surface of the substrate 210. In this regard, the acoustic exciter 200 may be configured to maintain substantially continuous contact of the plurality of excitation elements 208 with the substrate 210.

In some implementations, the motor 204 may be selected and/or configured to enhance the likelihood that the plurality of excitation elements 208 maintain substantially continuous contact with the surface of the substrate 210. For example, the speed at which the motor 204 rotates the head 202 may introduce radial forces that are not found in linear arrangements of excitation elements 208. At high enough speeds, one or more of the excitation elements 208 may change their vertical distance to the surface. A threshold torque may need to be applied by the motor 204 before the excitation elements 208 will initially begin to rotate along the surface of the substrate 210. However, as the speed of rotation increases and one or more excitation elements 208 bounce off of the surface, the excitation elements 208 may reduce the overall interfacial friction. Reducing the overall interfacial friction may then increase the speed of rotation of the head 202, which in turn may result in fewer interactions with the surface of the substrate 210. Eventually, the rotational speed may increase to a point that substantially all of the excitation elements may leave the surface and simply rotate in the air above the substrate 210.

To reduce the likelihood of such a situation, the acoustic exciter 200 may be provided with a motor 204 having a geared system with substantial torque at low speeds and/or with a feedback system to limit the maximum rotation speed of the excitation elements 208 in response to reduced friction with the surface of the substrate 210. This may produce a continuous, high torque rotation. To illustrate, based on gearing of the motor 204, significant torque may be applied initially, resulting in the excitation elements 208 maintaining contact with the substrate 210. A geared system with substantial torque at low speeds or a rotation speed feedback system may operate to limit a maximum rotation speed of the plurality of excitation elements 208 in response to situations with reduced friction with the substrate 210 in order to maintain contact with the surface of the substrate 210 during an interrogation.

The motor 204 may be provided as an electric motor, as a gas-powered motor, or as another source of power that is capable of rotating the head 202 about the axis of rotation AR. In a preferred implementation, the head 202 may be mechanically coupled to a motor 204 (e.g., an electrical motor) that can provide the force necessary to move the excitation elements 208 along a continuous path that may be circular, ellipsoidal, or another shape and/or also somewhat determined by the speed and collisions of the excitation elements 208 with the surface.

The rotational speed at which the motor 204 drives rotation of the head 202 may be based on a speed at which the platform 226 traverses the substrate 210. For example, the acoustic exciter 200 may be configured such that the motor 204 may increase or decrease the rotational speed of the head 202 proportionally with movement speed of the platform 226. To illustrate, the motor 204 may reduce rotational speed of the head 202 as the movement speed of the platform 226 slows but continues to provide excitation once the platform 226 is completely stopped.

In some implementations, the acoustic exciter 200 may be configured such that the motor 204 counter-rotates the head 202 relative to the direction of movement of the platform 226 in order to speed up the movement of the excitation elements 208 relative to the surface of the substrate 210 to be interrogated. In some implementations, the acoustic exciter 200 be configured to rotate the head 202 in the direction relative to the movement of the platform 226 to slow down movement of excitation elements 208 relative to the surface of the substrate 210 to be interrogated, thus allowing operation of the acoustic exciter 200 at higher speeds by slowing down the relative speed of impacts.

Feedback related to acoustic signals or position of the excitation elements 208 may be used to control the rotational speed at which the head 202 is driven by the motor 204 to adjust for the intensity of impacts and the speed of the excitation elements 208 relative to the surface of the substrate 210.

In some implementations, the acoustic exciter 200 may be configured such that the motor 204 periodically reverses the direction of rotation of the head 202 about the axis of rotation AR. For example, the acoustic exciter 200 may be configured such that the motor rotates the head 202 in a clockwise direction for a first interval of time, rotates the head 202 in a counter-clockwise direction for a second interval of time, rotates the head 202 in a clockwise direction for a third interval of time, and so on. This pattern of changing the direction of rotation of the head 202 may be designed such the plurality of excitation elements 208 can impart sufficient energy into the surface of the substrate 210 but not spin so fast that excitation elements 208, such as those along the edges of the excitation path for instance, leave the surface of the substrate 210 to be interrogated. In some implementations, this may cause the excitation elements 208 to generate an S-shaped (e.g., snake-like) motion along the length of the chain 222.

In some implementation, constant rotational speed of the head 202 may be preferred over the delivery of constant power by the motor 204. Under a constant power delivery scenario, it was observed that, if friction is reduced substantially between the excitation elements 208 and the surface of the substrate 210, the spinning motion may accelerate further, which may lift more excitation elements 208 from the surface of the substrate 210, for instance to the point that substantially all of the excitation elements 208 may leave the surface simultaneously. Accordingly, adjusting the rotation speed imparted to the head 202 by the motor 204 to maintain substantially continuous contact between the excitation elements 208 and the surface of the substrate 210 is preferred. This principle was verified in multiple experiments with different implementations of the acoustic exciter 200.

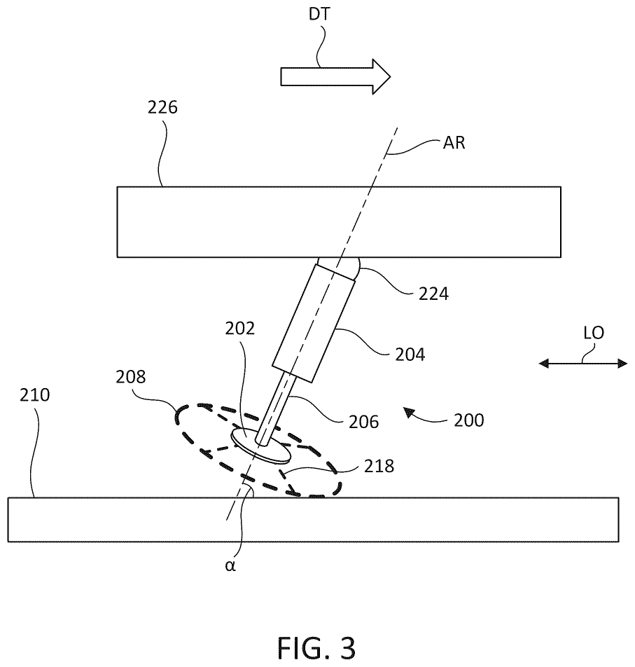

FIG. 3 is a side view of the acoustic exciter 200 in operation, with the acoustic exciter 200 repositioned relative to the platform 226. In some implementations, the motor 204 may be repositioned relative to the platform 226 via the coupler 224, such that an angle α between the axis of rotation AR a surface of the substrate 210 changes. To illustrate, the motor 204 may be repositioned from a first position in which the axis of rotation AR is substantially orthogonal relative to the surface of the substrate 210 such that α˜90° (e.g., as shown in FIGS. 2A-2B) to a second position in which α<90° as shown.

As shown, the acoustic exciter 200, and in particular the motor 204, may be repositioned such that the motor 204 is tilted rearward in the longitudinal direction LO, relative to a direction of travel DT of the platform 226 along the substrate 210. With the acoustic exciter 200 repositioned as shown, a quantity of the plurality of excitation elements 208 that simultaneously make contact with the substrate 210 is reduced. Stated differently, repositioning the acoustic exciter 200 relative to the platform 226 may result in varying the quantity of the plurality of excitation elements 208 that simultaneously make contact with the substrate 210.

In some implementations, reducing the quantity of the plurality of excitation elements 208 that simultaneously make contact with the substrate 210 may alter the excitation path that is applied to the substrate 210 by the excitation elements 208. For example, with the acoustic exciter 200 repositioned as shown, the excitation path applied to the substrate 210 by the excitation elements 208 will be arc shaped.

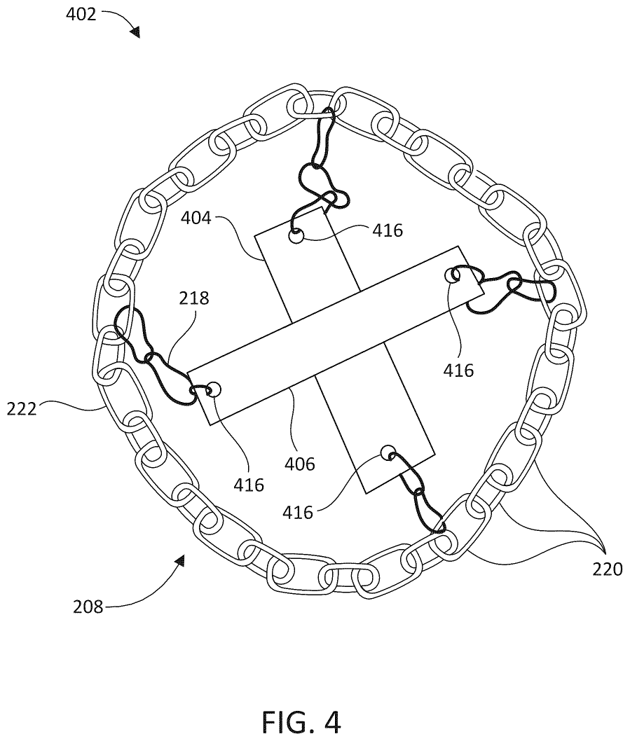

FIG. 4 is a perspective view of an example head 402 that may be implemented in an acoustic exciter. For instance, in some implementations the head 402 may be implemented in place of the head 202 in the acoustic exciter 200 (e.g., attached to the first end 212 of the shaft 206). As shown, the head 402 includes a first bar 404 and a second bar 406 that are attached to one another in a cross configuration. In some implementations, the head 402 may include one or more attachment locations 416 that are configured to enable attachment of the plurality of excitation elements 208 to the head 402. For example, as shown the head 402 includes four attachment locations 416, including two at opposed ends of the first bar 404 and two at opposed ends of the second bar 406.

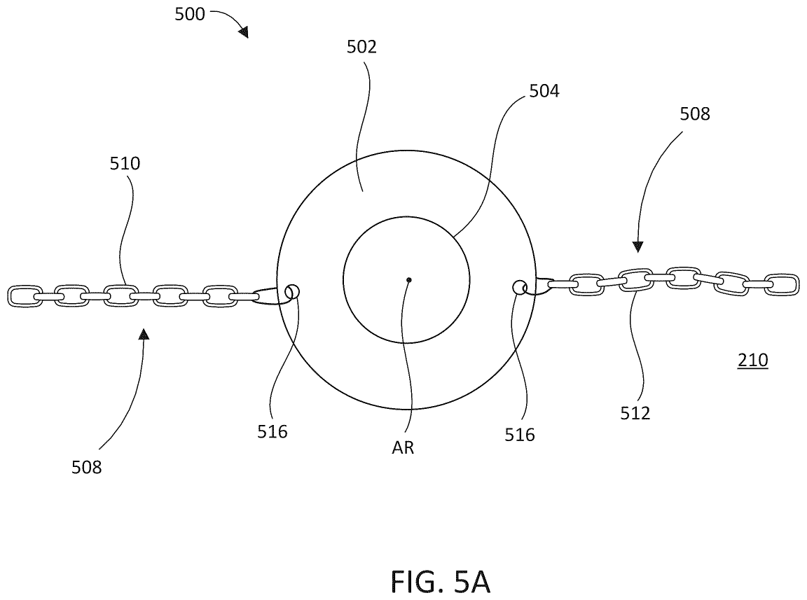

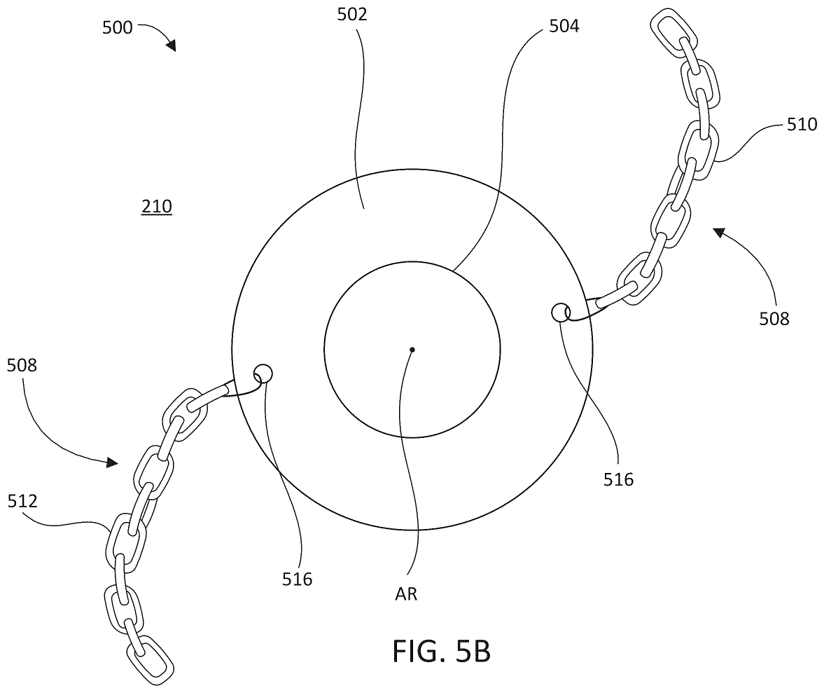

FIGS. 5A and 5B are top views of another example acoustic exciter 500. The acoustic exciter 500 may be implemented, for example, as the exciter 102 of the acoustic excitation system 100. In some implementations, the acoustic exciter 500 includes a head 502, a motor 504, and one or more excitation elements 508. As shown, the acoustic exciter 500 includes a plurality of excitation elements 508. The excitation elements 508 may be configured to contact a substrate 210 to cause acoustic excitation in the substrate 210. Although not shown, the acoustic exciter 500 may include a shaft that couples the head 502 to the motor 504 and a coupler that is configured to mount the motor 504 to a platform (e.g., such as the platform 110 of the acoustic excitation system 100).

In some implementations, the plurality of excitation elements 508 may comprise separate two or more separate portions of excitation elements 508 that are supported by the head 502. For example, as shown the plurality of excitation elements 508 comprises a first segment 510 of excitation elements 508 and a second segment 512 of excitation elements 508 that is separate from the first segment 510.

As shown, the head 502 is disc-shaped and includes two attachment locations 516 that are spaced apart from one another around a circumference of the head 502. More specifically, the head 502 includes a first attachment location 516 that is configured to support the first segment 510 of the plurality of excitation elements 508 and a second attachment location 516 that is configured to support the second segment 512 of the plurality of excitation elements 508.

In some implementations, the acoustic exciter 500 may be configured such that the motor 504 rotates the head 502 at a rotational speed that causes the first segment 510 and the second segment 512 of the plurality of excitation elements 508 to move in a substantially circular excitation path, wherein adjacent interconnected links 220 generally follow one another along the excitation path. This may result in an excitation path having an annular shape, which may be wider than the excitation path formed by the excitation elements 208 of the acoustic exciter 200.

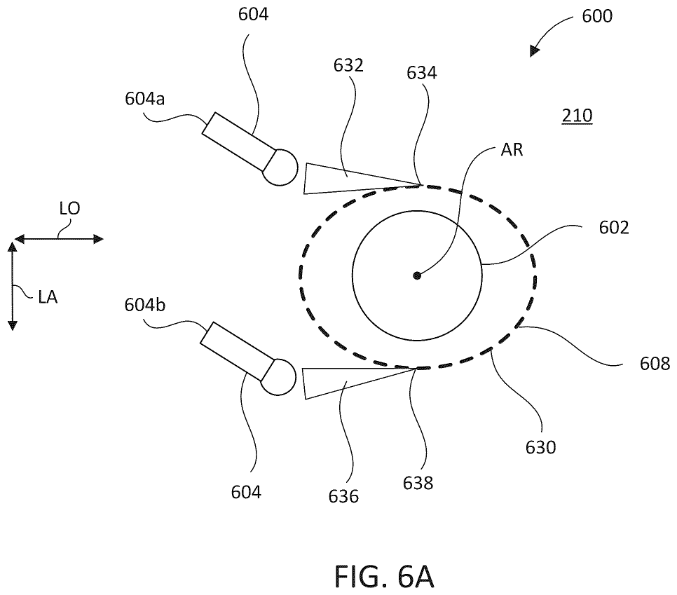

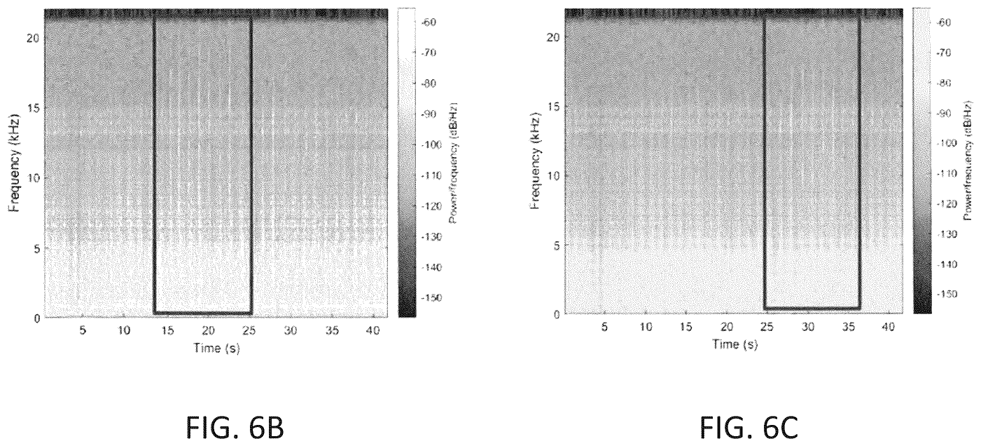

FIG. 6A is a block diagram depicting an example acoustic excitation system 600 in accordance with the present disclosure. The acoustic excitation system 600 may be implemented, for example, as the acoustic excitation system 100. In some implementations, the acoustic excitation system 600 may include an acoustic exciter 602 and one or more sensors 604. For example, as shown the acoustic excitation system 600 includes two sensors 604, including a first sensor 604a and a second sensor 604b.

In some implementations, the sensors 604 may be provided as microphones (e.g., microphones with directional gain). Such microphones may be used to sense possible defects at multiple points along a path of excitation of the acoustic excitation system 600. This may provide additional spatial information obtained along the path of excitation, for example when compared with known interrogation techniques.

As shown, the acoustic exciter 602 may include a plurality of excitation elements 608 that form an oval-shaped excitation path 630 along a surface of the substrate 210 during operation of the acoustic excitation system 600.

As shown, the acoustic excitation system 600 is configured such that the first sensor 604a is oriented to sense a first acoustic response 632 caused at a first location 634 along the excitation path 630 by the plurality of excitation elements 608, and such that the second sensor 604b is oriented to sense a second acoustic response 636 caused at a second location 638 along the excitation path 630 by the plurality of excitation elements 608.

In some implementations, the acoustic excitation system 600 may include one or more analysis components that are configured to determine at least one characteristic of the substrate 210 (e.g., the roadway or other material), for example using information related to the sensed first acoustic response 632 and the sensed second acoustic response 636. The one or more analysis components may be implemented in accordance with the one or more analysis components 106 of the acoustic excitation system 100, for example. In accordance with the illustrated implementation, the one or more analysis components may include circuitry configured to determine at least one characteristic of the substrate 210 based on the first acoustic response 632 and the second acoustic response 636.

An advantage of having an acoustic excitation system that maintains substantially continuous impacts of its excitation elements, such as the acoustic excitation system 600, for example, is that a path of interrogation of such an acoustic excitation system may cover more area of a substrate than may be covered by other known interrogation systems, such as those that employ point impacts, for example. Data from multiple sensors may be collected along a path of interrogation.

To illustrate, FIGS. 6B and 6C are spectrograms that depict example results based on acoustic data collected by the first sensor 604a and the second sensor 604b during interrogation of the substrate 210 by the acoustic excitation system 600. The acoustic data was analyzed as shown in FIGS. 6B and 6C, illustrating how employing multiple sensors 604, such the first sensor 604a and the second sensor 604b can pick up different defect information along an interrogation path.

In accordance with the illustrated results, the excitation elements 608 may produce broadband acoustic excitation that is particularly notable in the frequency region between 15 and 20 kHz. It should be noted that first the impacts between 15 and 25 seconds appear stronger on the first sensor 604a and then the impacts between 25 and 35 seconds appear stronger on the second sensor 604b. This may indicate that spatial source separation is possible along a single continuous excitation path of the excitation elements 608 as the acoustic excitation system 600 traverses the substrate 210. The illustrated results are based on a configuration in which a platform to which the acoustic excitation system 600 is mounted remains stationary, thereby demonstrating the utility of active mechanical rotations of the excitation elements 608 for interrogation at low speeds and/or when the acoustic excitation system 600 in not moving.

As shown, the first sensor 604a and the second sensor 604b may be provided as respective first and second microphones, each microphone having directional acoustic patterns, may be directed towards different points (e.g., the first location 634 and the second location 638) of the continuous excitation along the surface of the substrate 210. In some implementations, the first sensor 604a and the second sensor 604b may be connected to a multichannel amplifier and digitizer. Acoustic signals may be recorded, for example by a computer running sound software in which multiple channels of acoustic data are recorded simultaneously.

In some implementation, the acoustic excitation system 600 may include a platform to which the acoustic exciter 602 and the sensors 604 are mounted. In such an implementation, a platform may enable movement of the excitation elements 608, for example in the longitudinal direction LO, the latitudinal direction LA, or a combination thereof. The acoustic excitation system 600 may be configured to enable adjustment of a height of the excitation elements 608 (e.g., vertically) relative to the surface of the substrate 210 to be interrogated. In some implementations, the sensors 604 may be mounted to the platform such that respective orientations of the sensors 604 are maintained relative to the excitation elements 608.

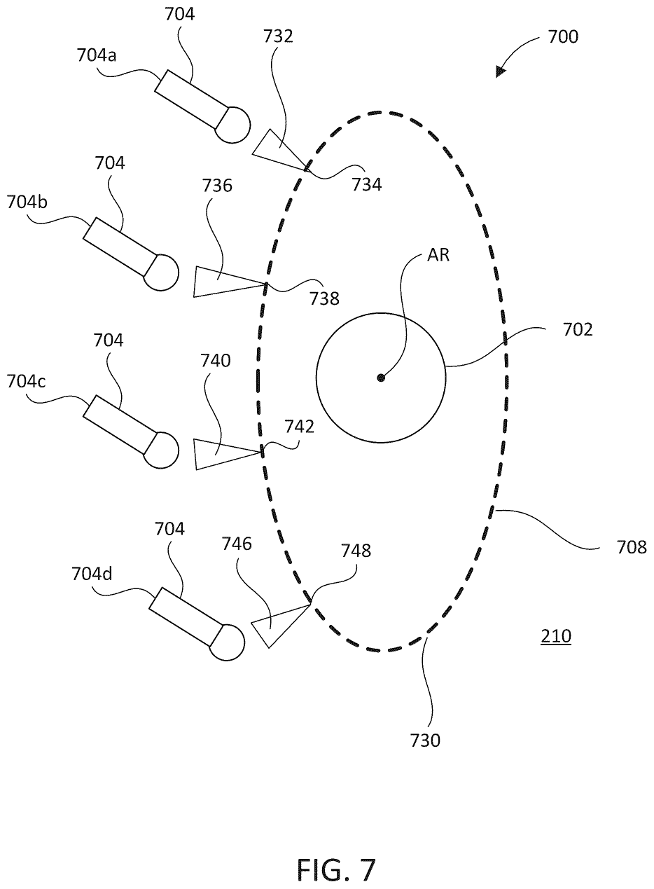

It should be appreciated that acoustic excitation systems may be implemented with any number of acoustic exciters and/or sensors, for example in accordance with characteristics of the substrate 210 which is to be interrogated. For example, FIG. 7 is a block diagram depicting an example acoustic excitation system 700. The acoustic excitation system 700 may be implemented, for example, as the acoustic excitation system 100.

In some implementations, the acoustic excitation system 700 may include an acoustic exciter 702 and one or more sensors 704. For example, as shown the acoustic excitation system 700 includes four sensors 604, including a first sensor 704a, a second sensor 704b, a third sensor 704c, and a fourth sensor 604d.

In some implementations, the sensors 604 may be provided as microphones (e.g., microphones with directional gain). Such microphones may be used to sense possible defects at multiple points along a path of excitation of the acoustic excitation system 700.

As shown, the acoustic exciter 702 may include a plurality of excitation elements 708 that form an oval-shaped excitation path 730 along a surface of the substrate 210 during operation of the acoustic excitation system 700.

As shown, the acoustic excitation system 700 is configured such that the first sensor 704a is oriented to sense a first acoustic response 732 caused at a first location 734 along the excitation path 730 by the plurality of excitation elements 708, such that the second sensor 704b is oriented to sense a second acoustic response 736 caused at a second location 738 along the excitation path 730 by the plurality of excitation elements 708, such that the third sensor 704c is oriented to sense a third acoustic response 740 caused at a third location 742 along the excitation path 730 by the plurality of excitation elements 708, and such that the fourth sensor 704d is oriented to sense a fourth acoustic response 746 caused at a fourth location 748 along the excitation path 730 by the plurality of excitation elements 708.

In some implementations, the acoustic excitation system 700 may include one or more analysis components that are configured to determine at least one characteristic of the substrate 210 (e.g., the roadway or other material), for example using information related to the sensed first acoustic response 732, the sensed second acoustic response 736, the sensed third acoustic response 740, and the sensed fourth acoustic response 746. The one or more analysis components may be implemented in accordance with the one or more analysis components 106 of the acoustic excitation system 100, for example. In accordance with the illustrated implementation, the one or more analysis components may include circuitry configured to determine at least one characteristic of the substrate 210 based on the first acoustic response 732, the second acoustic response 736, the third acoustic response 740, and the fourth acoustic response 746.

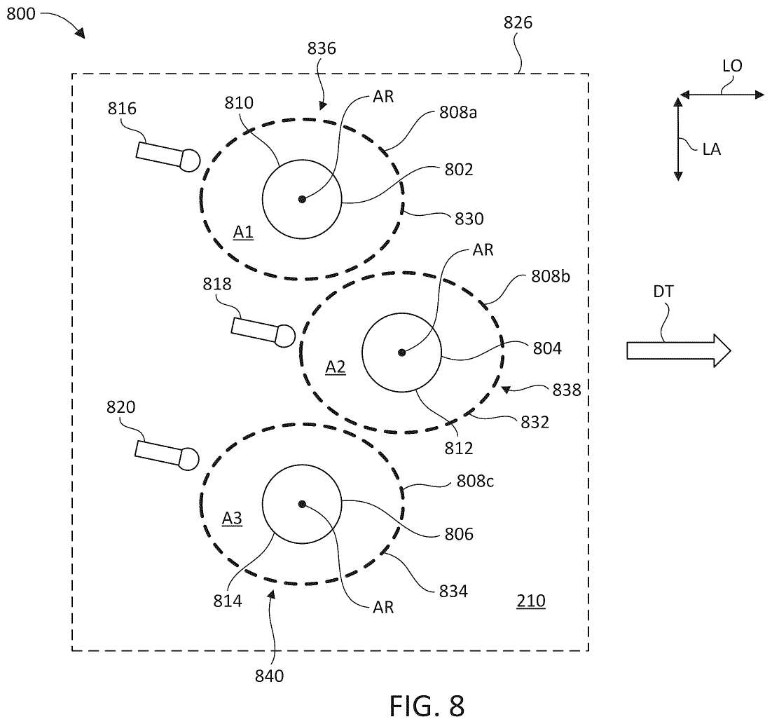

FIG. 8 is a block diagram depicting an example acoustic excitation system 800. The acoustic excitation system 800 may be implemented, for example, as the acoustic excitation system 100.

In some implementations, the acoustic excitation system 800 may include two or more acoustic exciters. For example, as shown the acoustic excitation system 800 may include a first acoustic exciter 802, a second acoustic exciter 804, and a third acoustic exciter 806. The first acoustic exciter 802, the second acoustic exciter 804, and the third acoustic exciter 806 may be implemented in accordance with any of the example acoustic exciters described herein, such as the acoustic exciter 200 for example.

In accordance with the illustrated implementation, the first acoustic exciter 802 may include a first plurality of excitation elements 808a that form an oval-shaped first excitation path 830 along a surface of the substrate 210. The first acoustic exciter 802 may include a first motor 810 that is configured to agitate the first plurality of excitation elements 808a (e.g., via rotating the excitation elements 808a about an axis of rotation AR of the first motor 810) to cause acoustic excitation of the substrate 210.

Additionally, the second acoustic exciter 804 may include a second plurality of excitation elements 808b that form an oval-shaped second excitation path 832 along the surface of the substrate 210. The second acoustic exciter 804 may include a second motor 812 that is configured to agitate the second plurality of excitation elements 808b (e.g., via rotating the excitation elements 808b about an axis of rotation AR of the second motor 812) to cause acoustic excitation of the substrate 210.

Furthermore, the third acoustic exciter 806 may include a third plurality of excitation elements 808c that form an oval-shaped third excitation path 834 along the surface of the substrate 210. The third acoustic exciter 806 may include a third motor 814 that is configured to agitate the third plurality of excitation elements 808c (e.g., via rotating the excitation elements 808c about an axis of rotation AR of the third motor 814) to cause acoustic excitation of the substrate 210.

In some implementations, each of the first acoustic exciter 802, the second acoustic exciter 804, and the third acoustic exciter 806 may include one or more sensors. For example, as shown the first acoustic exciter 802 may include a first sensor 816 that is oriented to sense a first acoustic response associated with (e.g., caused by) the first plurality of excitation elements 808a, the second acoustic exciter 804 may include a second sensor 818 that is oriented to sense a second acoustic response associated with (e.g., caused by) the second plurality of excitation elements 808b, and the third acoustic exciter 806 may include a third sensor 820 that is oriented to sense a third acoustic response associated with (e.g., caused by) the third plurality of excitation elements 808c.

In some implementations, the acoustic excitation system 800 may include one or more analysis components that are configured to determine at least one characteristic of the substrate 210 (e.g., the roadway or other material), for example using information related to the first acoustic response sensed by the first sensor 816, the second acoustic response sensed by the second sensor 818, and the third acoustic response sensed by the third sensor 820. The one or more analysis components may be implemented in accordance with the one or more analysis components 106 of the acoustic excitation system 100, for example. In accordance with the illustrated implementation, the one or more analysis components may include circuitry configured to determine at least one characteristic of the substrate 210 based on the first acoustic response, the second acoustic response, and the third acoustic response.

In some implementations, the acoustic excitation system 800 may include a platform 826 to which the first acoustic exciter 802, the second acoustic exciter 804, and the third acoustic exciter 806 are mounted, for example via respective couplers (e.g., such as the coupler 224 of the acoustic exciter 200). In some implementations, the platform 826 may be configured to traverse the substrate 210 along a direction of travel DT. In some implementations, the first sensor 816, the second sensor 818, and the third sensor 820 may be attached to the platform 826.

As shown, each of the first acoustic exciter 802, the second acoustic exciter 804, and the third acoustic exciter 806 may be positioned such that the axes of rotation AR of the first motor 810, the second motor 812, and the third motor 814, respectively, are aligned substantially orthogonally with a surface of the substrate 210. In accordance with this configuration, the first acoustic exciter 802 may be configured to maintain substantially continuous contact of the first plurality of excitation elements 808a with the substrate 210, the second acoustic exciter 804 may be configured to maintain substantially continuous contact of the second plurality of excitation elements 808b with the substrate 210, and the third acoustic exciter 806 may be configured to maintain substantially continuous contact of the third plurality of excitation elements 808c with the substrate 210.

In accordance with the illustrated configuration of the acoustic excitation system 800, the first acoustic exciter 802 may be mounted to the platform 826 at a first location 836 such that it causes acoustic excitation of the substrate 210 in a first area A1 defined by the first excitation path 830, the second acoustic exciter 804 may be mounted to the platform 826 at a second location 838 such that it causes acoustic excitation of the substrate 210 in a second area A2 defined by the second excitation path 832, and the third acoustic exciter 806 may be mounted to the platform 826 at a third location 840 such that it causes acoustic excitation of the substrate 210 in a third area A3 defined by the third excitation path 834.

As shown, the first location 836 may be aligned with the third location 840 along the longitudinal direction LO and the second location 838 may be spaced from the first location 836 and the third location 840 along the longitudinal direction LO. Additionally, the first location 836 may be spaced from the third location 840 along the lateral direction LA, and the second location 838 may be spaced from the first location 836 and the third location 840 along the lateral direction LA, for example such that the second location 838 is located equidistantly from the first location 836 and the third location 840 along the lateral direction LA.

In some implementations, the first location 836, the second location 838, and the third location 840 may be configured such that respective paths of interrogation of the first acoustic exciter 802, the second acoustic exciter 804, and the third acoustic exciter 806 at least partially overlap, for example as the platform 826 traverses the substrate 210 along the direction of travel DT and the acoustic excitation system 800 interrogates the substrate 210. For example, as shown the second location 838 may be spaced from the first location 836 (e.g., along one or both of the longitudinal direction LO and the lateral direction LA) such that the second area A2 at least partially overlaps the first area A1, and third location 840 may be spaced from the second location 838 (e.g., along one or both of the longitudinal direction LO and the lateral direction LA) such that the third area A3 at least partially overlaps the second area A2.

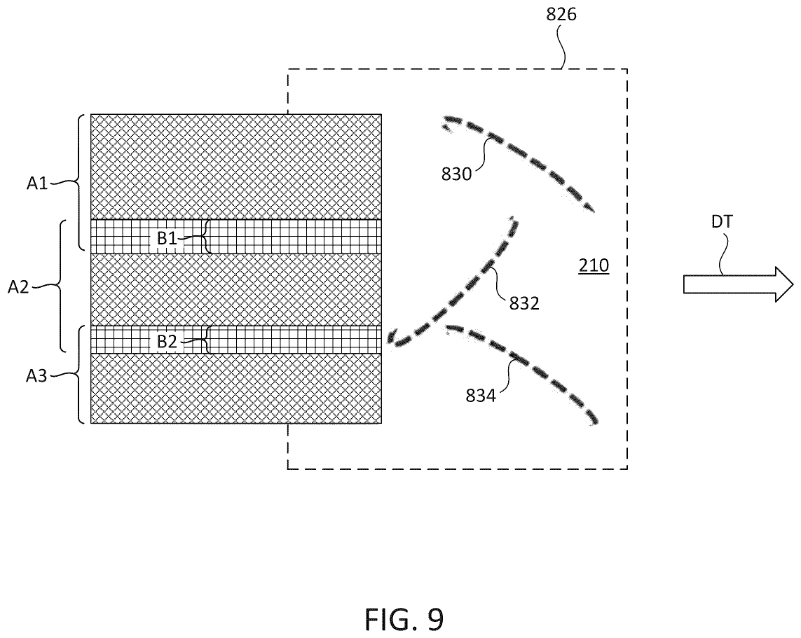

FIG. 9 is a block diagram illustrating an example of operation of the acoustic excitation system 800 interrogating the substrate 210. As shown, the first acoustic exciter 802, the second acoustic exciter 804, and the third acoustic exciter 806 may be repositioned such the respective axes of rotation AR are no longer orthogonal relative to the surface of the substrate 210. This may result in the first excitation path 830, the second excitation path 832, and the third excitation path 834 forming arc-shaped geometries of contact with the substrate 210. As shown, as the platform 826 traverses the substrate 210 along the direction of travel DT, the coverage of the first area A1, the second area A2, and the third area A3 may partially overlap one another, creating bands B1 and B2 of overlapping coverage.

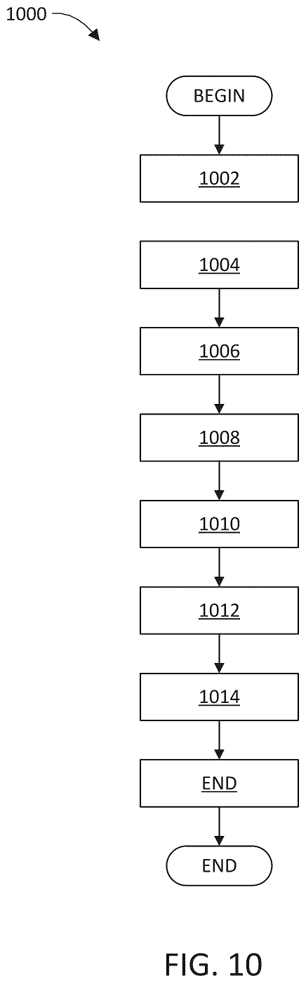

FIG. 10 is a flow diagram of an example process 1000 for operating an acoustic excitation system. The process 1000 may be implemented with any acoustic excitation system implemented in accordance with the instant disclosure, for example one or more of the acoustic excitation system 100, the acoustic excitation system 600, the acoustic excitation system 700, or the acoustic excitation system 800.

In an example implementation, the process 1000 may be utilized in a scenario in which the acoustic exciters of an acoustic excitation system are activated to drive respective excitation elements before a platform on which components of the acoustic excitation system are mounted enters an area to interrogated.

At step 1002, an interrogation area of a substrate (e.g., the substrate 210) may be determined.

At step 1004, the acoustic exciters of the acoustic excitation system may be activated to drive respective excitation elements, for example by rotating respective pluralities of excitation elements about respective axes of rotation of the acoustic exciters. Optionally at step 1004, one or more acoustic exciters of the acoustic excitation system may be repositioned (e.g., as described elsewhere herein), which may cause reconfiguration of the respective excitation paths of one or more of the pluralities of excitation elements.

At step 1006, a platform upon which the acoustic exciters are mounted may be controlled to move into the interrogation area.

At step 1008 the platform may advance within the interrogation area along a direction of travel, with the acoustic exciters providing acoustic excitation in the substrate by maintaining substantially continuous contact of the pluralities of excitation elements with the surface of the substrate. As the platform traverses through the interrogation area, data may be collected. For example, one or more sensors of the acoustic excitation system may sense acoustic responses in the substrate caused by the acoustic excitation provided by the pluralities of excitation elements.

One or more aspects, such as all aspects, of the data collection of may be automated, including but not limited to repositioning one or more of the acoustic exciters during interrogation, varying rotational speed of one or more of the pluralities of excitation elements, and the starting and/or stopping of data collection. The automated system can perform these tasks based on the estimated position of the platform (e.g., in the longitudinal direction LO or the lateral direction LA), for example, by causing the one or more acoustic exciters to initiate agitation of the pluralities of excitation elements as the platform approaches the interrogation area, collecting acoustic response data while the platform traverses the interrogation area, and ceasing data collection and/or causing agitation of the pluralities of excitation elements to be ceased as the platform leaves the interrogation area.

In some implementations, the acoustic excitation system may be configured to determine whether a portion of the interrogation area (e.g., a lane of a bridge) needs to be scanned or if it has already been scanned and control components of the system accordingly. If the system is operated in this fashion, a single operator can accomplish all tasks because all of the data collection aspects can be controlled by a computer. The operator can simply make sure the platform is positioned properly within the interrogation area during traversal of the platform while the acoustic excitation system performs its functions.

Furthermore, in some implementations the acoustic excitation system may be configured to operate in a fully autonomous manner, for example to carry out scanning in a pre-determined interrogation area, without any intervention by an operator.

At step 1010, the platform may reach the end of the interrogation area.

At step 1012, upon the platform leaving the interrogation area, the one or more acoustic exciters of the acoustic excitation system may be controlled to cease agitation of the pluralities of excitation elements.

At step 1014, acoustic response data acquired during acoustic excitation in the interrogation area may be processed. In some implementations, the data may be processed into one or more maps of the interrogation area that identify any areas of defects (e.g., delaminations) detected in the substrate.

In some implementations, signal processing techniques may be based on machine learning to additionally process the data and extract relevant features from the audio record. For example, a machine learning technique can be applied to the data and/or signals of acoustic responses in order to learn (e.g., develop algorithms or pattern recognition) how to identify material that may have one or more particular characteristics (e.g., due to being delaminated).

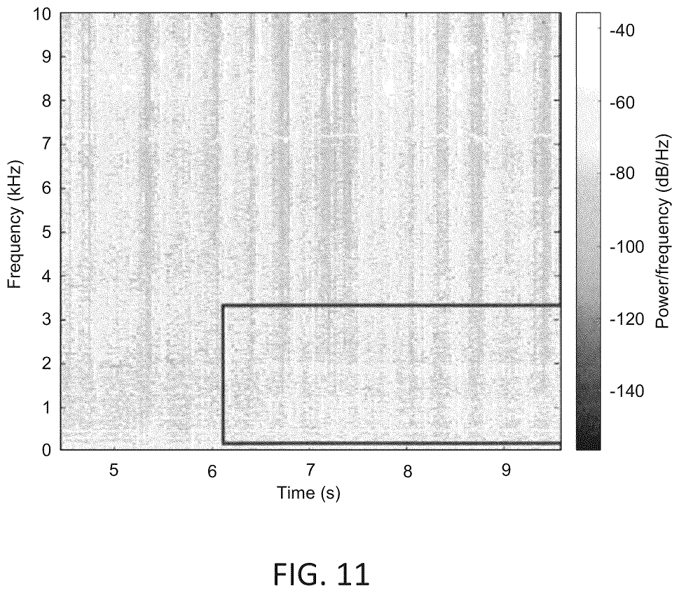

FIG. 11 is a spectrogram displaying results derived from acoustic response data collected during an acoustic excitation interrogation process in accordance with the process 1000. The interrogation was performed on reinforced concrete slabs with intact and delaminated sections as the platform traversed along an edge of the slab. Acoustic responses were collected with a microphone and recorded. Post-processing to form the spectrogram was performed in MATLAB. In this spectrogram, no delamination is detected before approximately 6 seconds. Delamination is clearly detected after 7 seconds. In this spectrogram, it can be noted that the frequency bands at approximately 1 and 2 kHz correspond to the “hollow” sound of a natural delamination.

It should be appreciated that the process 1000 for operation of the acoustic excitation systems illustrated and described herein is not limited to the disclosed steps. For example, the process 1000 may be implemented differently with more or fewer steps, with additional steps that are not described herein, with one or more of the disclosed steps omitted, and so on in any combination. To illustrate, in an example of a different implementation the process 1000 may be differently implemented to operate the acoustic excitation systems of the instant disclosure by combining steps 1004 and 1006 to execute simultaneously. In another example of a different implementation of the process, the data processing of the data at step 1014 may be performed in real time as the interrogation is carried out, for example simultaneously with step 1008. In such an implementation, map data corresponding to the interrogation may be provided to an operator of the acoustic excitation system, for example displayed on a screen.

It should further be appreciated that the acoustic exciters and acoustic excitation system illustrated and described herein are not limited to implementations in which lengths of chain are provided as the excitation elements. In some implementations, other types of elements may be provided for use in imparting acoustic excitation to a substrate. For example, in a different implementation, an acoustic exciter may include a contact element (e.g., of spherical and/or cylindrical shape) that is configured for triggering the acoustic excitation. In some implementations, a contact element may have another shape. For example, and without limitation, contact elements can be prismatic, triangular, or oval. For example, contact elements can include, but are not limited to, cylindrical, rod-shaped, spherical, elliptical, or rounded objects. The contact elements can be made of a suitably hard material, such as steel for example.

Implementations of the various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium) for processing by, or to control the operation of, data processing apparatus, e.g., a programmable processor, a computer, or multiple computers. In some implementations, a tangible computer-readable storage medium can be configured to store instructions that when executed cause a processor to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

In some implementations, process steps may be performed by one or more programmable processors executing a computer program to perform functions by operating on input data and generating output. In some implementations, process steps may be performed by, and an apparatus may be implemented as, special-purpose logic circuitry (e.g., an FPGA (field programmable gate array) or an ASIC (application-specific integrated circuit)).

Processors suitable for the processing of a computer program include, by way of example, both general and special-purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data (e.g., magnetic, magneto-optical disks, or optical disks). Information carriers suitable for embodying computer program instructions and data include all forms of non-volatile memory, including by way of example semiconductor memory devices (e.g., EPROM, EEPROM, and flash memory devices; magnetic disks (e.g., internal hard disks or removable disks); magneto-optical disks; and CD-ROM and DVD-ROM disks. The processor and the memory may be supplemented by, or incorporated in special-purpose logic circuitry.

To provide for interaction with a user, implementations may be implemented on a computer having a display device (e.g., a cathode ray tube (CRT), a light emitting diode (LED), or liquid crystal display (LCD) device) for displaying information to the user and a keyboard and a pointing device, e.g., a mouse or a trackball, by which the user can provide input to the computer. Other kinds of devices can be used to provide for interaction with a user, as well; for example, feedback provided to the user can be any form of sensory feedback (e.g., visual feedback, auditory feedback, or tactile feedback), and input from the user can be received in any form, including acoustic, speech, or tactile input.

Implementations may be implemented in a computing system that includes a back-end component (e.g., as a data server), or that includes a middleware component (e.g., an application server), or that includes a front-end component (e.g., a client computer having a graphical user interface or a Web browser through which a user can interact with an implementation), or any combination of such back-end, middleware, or front-end components. Components may be interconnected by any form or medium of digital data communication (e.g., a communication network). Examples of communication networks include a local area network (LAN) and a wide area network (WAN) (e.g., the Internet).

It will also be understood that when an element, such as a layer, a region, or a substrate, is referred to as being on, connected to, electrically connected to, coupled to, or electrically coupled to another element, it may be directly on, connected to, or coupled to the other element, or one or more intervening elements may be present. In contrast, when an element is referred to as being directly on, directly connected to, or directly coupled to another element or layer, there are no intervening elements or layers present. Although the terms directly on, directly connected to, or directly coupled to may not be used throughout the detailed description, elements that are shown as being directly on, directly connected, or directly coupled can be referred to as such. The claims of the application may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes, and equivalents will now occur to those skilled in the art. It is, therefore, to be understood that claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A system comprising:
an acoustic exciter configured to be supported by a platform and having a plurality of excitation elements configured to rotate about an axis of rotation to cause acoustic excitation of a substrate via contact with the substrate, the acoustic exciter configured to be repositionable relative to the platform to alter an excitation path applied to the substrate by the excitation elements; and
a sensor configured to sense an acoustic response of the acoustic excitation.

2. The system of claim 1, wherein the acoustic exciter includes:
a head that is configured to support the plurality of excitation elements in a hanging arrangement;
a shaft having a first end that is coupled to the head and a second end that is spaced from the first end, the shaft defining the axis of rotation; and
a motor that is coupled to the second end of the shaft and configured to rotate the shaft around the axis of rotation.

3. The system of claim 2, wherein the acoustic exciter further includes:
a coupler that is configured to mount the motor to the platform such that the motor is repositionable relative to the platform to vary an angle between the axis of rotation and a surface of the substrate.

4. The system of claim 3, wherein the coupler is configured to enable manual repositioning of the motor relative to the platform.

5. The system of claim 3, wherein the coupler is configured to enable automatic repositioning of the motor relative to the platform.

6. The system of claim 1, wherein altering the excitation path results from varying a quantity of the plurality of excitation elements that simultaneously make contact with the substrate.

7. The system of claim 1, further comprising:
circuitry configured to determine at least one characteristic of the substrate based on the acoustic response.

8. The system of claim 1, wherein the sensor is a first sensor oriented to sense a first acoustic response caused at a first location by the plurality of excitation elements, and wherein the system further comprises:
a second sensor oriented to sense a second acoustic response caused at a second location by the plurality of excitation elements.

9. The system of claim 8, further comprising:
circuitry configured to determine at least one characteristic of the substrate based on the first acoustic response and the second acoustic response.

10. A system comprising:
an acoustic exciter having a plurality of excitation elements, the acoustic exciter configured to maintain substantially continuous contact of the plurality of excitation elements with a substrate, the acoustic exciter including a motor that is configured to agitate the plurality of excitation elements to cause acoustic excitation of the substrate; and
a sensor oriented to sense an acoustic response of the acoustic excitation.

11. The system of claim 10, wherein the motor is configured to agitate the plurality of excitation elements by rotating the excitation elements about an axis of rotation.

12. The system of claim 11, wherein the acoustic exciter is a first acoustic exciter and the plurality of excitation elements is a first plurality of excitation elements, and wherein the system further comprises:
a second acoustic exciter having a second plurality of excitation elements, the second acoustic exciter configured to maintain substantially continuous contact of the second plurality of excitation elements with the substrate, the second acoustic exciter including a motor that is configured to agitate the second plurality of excitation elements to cause acoustic excitation of the substrate; and
a platform to which the first acoustic exciter and the second acoustic exciter are mounted, the platform configured to traverse the substrate along a direction of travel.

13. The system of claim 12, wherein the first acoustic exciter is mounted to the platform at a first location and causes acoustic excitation of a first area of the substrate, and
wherein the second acoustic exciter is mounted to the platform at a second location and causes acoustic excitation of a second area of the substrate, the second location spaced from the first location such that the second area at least partially overlaps the first area.

14. The system of claim 12, wherein the sensor is a first sensor and the acoustic response is a first acoustic response associated with the first plurality of excitation elements, and wherein the system further comprises:
a second sensor oriented to sense a second acoustic response associated with the second plurality of excitation elements.

15. The system of claim 14, further comprising:
circuitry configured to determine at least one characteristic of the substrate based on the first acoustic response and the second acoustic response.

16. The system of claim 11, wherein the acoustic exciter includes:
a head that is configured to support the plurality of excitation elements in a hanging arrangement; and
a motor that is configured to rotate the excitation elements about the axis of rotation,
wherein the axis of rotation is substantially orthogonal to a planar surface of the substrate.

17. An acoustic exciter comprising:
a plurality of excitation elements that are configured to contact a substrate to cause acoustic excitation in the substrate;
a head that is configured to support the plurality of excitation elements;
a shaft having a first end that is coupled to the head and a second end that is spaced from the first end, the shaft defining an axis of rotation of the head;
a motor that is coupled to the second end of the shaft and configured to rotate the shaft about the axis of rotation; and
a coupler that is configured to mount the motor to a platform such that the motor is repositionable relative to the platform to vary an angle between the axis of rotation and a surface of the substrate.

18. The acoustic exciter of claim 17, wherein the head is configured to support the plurality of excitation elements in a hanging arrangement.

19. The acoustic exciter of claim 17, wherein the coupler is configured to enable at least one of longitudinal tilt and lateral tilt of the motor relative to the platform.

20. The acoustic exciter of claim 17, wherein the coupler comprises a ball head coupler.

21. The acoustic exciter of claim 17, wherein the coupler comprises a multi-axis positioner.

22. The acoustic exciter of claim 17, wherein the head comprises a plurality of attachment locations that are spaced apart from one another and configured to enable attachment of the plurality of excitation elements to the head.

23. The acoustic exciter of claim 22, wherein the plurality of excitation elements comprises a plurality of interconnected links.

24. The acoustic exciter of claim 23, wherein the head is configured such that when the plurality of interconnected links is suspended from the plurality of attachment locations, respective segments of the plurality of interconnected links exhibit sag between adjacent ones of the plurality of attachment locations.

25. The acoustic exciter of claim 22, wherein the plurality of excitation elements comprises a first segment of excitation elements and a second segment of excitation elements that is separate from the first segment, and
wherein the head comprises a first attachment location configured to support the first segment of the plurality of excitation elements and a second attachment location configured to support the second segment of the plurality of excitation elements, the second attachment location spaced from the first attachment location.
